(19) United States
(12) Patent Application Publication
(10) Pub. No.: US 2005/0051686 A1
(43) Pub. Date: Mar. 10, 2005

(54) Adjustable mounting bracket arrangement

(76) Inventor: Derick Brian Payne, Peterborough (GB)

Correspondence Address: CATERPILLAR INC.;100 N.E. ADAMS STREET, PATENT DEPT., PEORIA, IL, 616296490, US

(21) Appl. No.: 10/659,506

(22) Filed: Sep. 10, 2003

(51) Int. Cl. F16M 11/00

(52) U.S. Cl. 248/200

(57) ABSTRACT

To mount articles onto two or more surfaces can be difficult if the relative position of the surfaces can vary due to for example manufacturing tolerances. This can cause high levels of residual stress in the mounting arrangement that especially in a high vibration environment can cause failures. Conventional mounting arrangements overcame this by complex or heavy designs, or by the use of methods such as shimming. This generally caused conventional designs to be expensive and cumbersome to fit. The disclosed arrangement comprises a simple and relatively inexpensive bracket and adjustable member, wherein the adjustable member can be adjusted to compensate for misalignment. After the bracket is fitted into position, the adjustable member can be positioned relatively to the bracket in such a manner that the bracket is fully supported by the adjustable member without any unwanted residual stress.

### TECHNICAL FIELD

This disclosure relates to a mounting bracket arrangement and more particularly to an adjustable mounting bracket for mounting articles to two or more offset surfaces.

### BACKGROUND

Internal combustion engines may carry a number of externally mounted accessories such as air-conditioning compressors, power steering pumps and alternators. These may be belt, gear or chain driven devices and carry therefore restrictions in positioning with regards to alignment. A common arrangement is to have several or even all pulleys driven by, and therefore aligned with, the driving crankshaft pulley. To mount accessories to an engine with regards to the above weight of the accessories, forces acting upon the accessories, maximum load carrying capacity of engine components, limited number of mounting points available on the engine and vibration caused by the engine and the accessories should be considered.

In one example, an engine for a passenger bus is required to be fitted with an alternator, a steering pump, a vacuum pump and in addition, two air-conditioning compressors. The bus frequently operates in hot conditions, therefore requiring separate air-conditioning systems for both the passenger compartment and the driver's area. Air-conditioning compressors place strenuous design requirements on mounting arrangements, due to size, weight and frequent shock loads from the engaging and disengaging clutches.

From the above, it follows that the bracket will likely have to be mounted to the engine by means of multiple mounting locations, especially since all loads are transverse to the longitudinal axis of the mounting locations and thus may induce torsional movement or high resulting forces. Engines tend not to have large surfaces in one plane, and consequently the mounting locations tend not be in the same plane or on a single component. Manufacturing and assembly tolerances introduce varying degrees of misalignment between several components and especially between the cylinder block and the cylinder head. If the tolerances are such that one or more mounting locations of the bracket is in contact with a surface on the engine only after tightening of a fastener, unwanted stress may be present in the bracket, which can lead to premature failure of the bracket.

In the past, this uneven bracket loading has been overcome by either complex or strengthened brackets, or an adjustment method such as shimming. This is not desirable, as a complex or strengthened bracket increases weight, size and cost of the bracket. Shimming has disadvantages in that it tends to be time consuming during assembly and shims can be awkward to fit.

The present disclosure is directed at overcoming one or more of the above identified issues.

### SUMMARY OF THE DISCLOSURE

According to one aspect of the present disclosure, there is provided a mounting bracket arrangement having a first surface lying substantially in a first plane, a second surface lying substantially in a second plane and a mounting bracket having a portion contacting the first surface. The bracket further has a passage extending therethrough adjacent the second surface. An adjustment member is positioned in the passage and has an end surface contacting the second surface and is adjustable along an axis. The bracket is adapted to support a load transverse to the axis.

According to another aspect of the present disclosure, there is provided a method for mounting an article to a first surface lying substantially in a first plane and a second surface lying substantially in a second plane. The method comprises: positioning a mounting bracket adjacent to the first and second surfaces, causing a portion of the mounting bracket to contact the first surface, engaging an adjustment member in a passage extending through the bracket adjacent to the second surface and adjusting the position of the adjustment member along an axis until an end surface of the adjustment member contacts the second surface. The bracket is adapted to support a load transverse to the axis.

Other features and aspects of this disclosure will be apparent from a reading of the following description and the accompanying drawings.

### BRIEF DESCRIPTION OF THE DRAWINGS

FIG. 1 is a front view of an internal combustion engine showing the mounting bracket arrangement, carrying an assortment of accessories.

FIG. 2 is a diagrammatic cross-sectional view of a portion of the mounting bracket arrangement.

FIG. 3 is a fragmentary view of a portion of the mounting bracket arrangement shown in FIG. 2, showing an alternative fastening arrangement.

FIG. 4 is an end view of a tubular member from part of the mounting bracket arrangement having internal portions for tool engagement.

FIG. 5 is a fragmentary view of a portion of the mounting bracket arrangement shown in FIG. 2, showing another alternative fastening arrangement.

### DETAILED DESCRIPTION

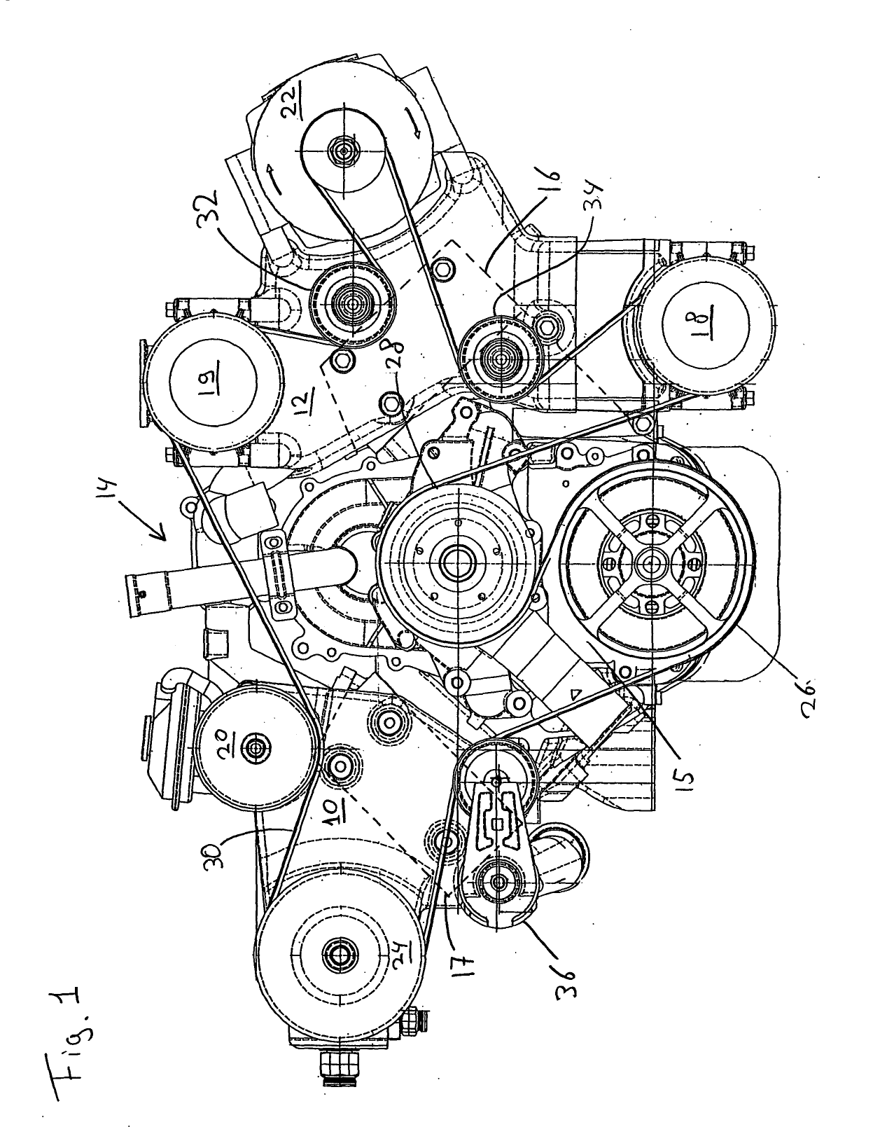

With reference to FIG. 1., a first mounting bracket 10 and a second mounting bracket 12 in accordance with this disclosure are fitted to an internal combustion engine 14. Engine 14 comprises a cylinder block 15 and cylinder heads 16 and 17. Brackets 10 and 12 secure air-conditioning compressors 18 and 19, a vacuum pump 20, an alternator 22 and a steering pump 24 to engine 14. Other types of articles may also be mounted and need not be belt, chain or gear driven. A crankshaft pulley 26 is the driving pulley and drives the aforementioned accessories in addition to a coolant pump 28 via a drive belt 30. In addition to the accessories, the brackets carry idler pulleys 32 and 34 and a belt tensioner 36. Coolant pump 28 is fitted directly onto the engine. First mounting bracket 10 and second mounting bracket 12 have substantially the same function and both share the same principle. For simplicity only mounting bracket 10 will be discussed further.

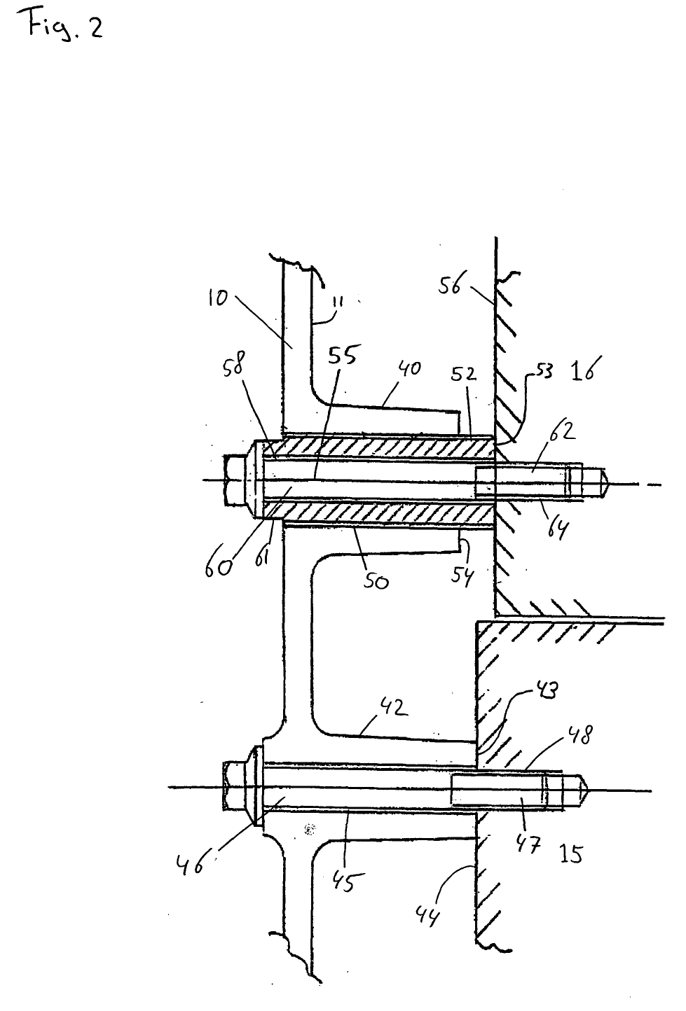

With reference to FIG. 2, mounting bracket 10 comprises a first projection 40 and a second projection 42, projection 42 extending further from surface 11 of bracket 10 than projection 40. For simplicity only one of each projections 40 and 42 are shown, but a plurality of substantially similar projections may be employed. A surface 43 of projection 42 is shown in direct contact with a surface 44 of cylinder block 15, however another object such as a washer or a bracket (not shown) can be fitted in between surface 43 and surface 44. Projection 42 is shown with a longitudinal passage 45 adapted to receive a fastener such as bolt 46. Bolt 46 has a threaded portion 47 that engages with a threaded hole 48 in cylinder block 15 to secure bracket 10 to cylinder block 15. Projection 40 comprises a surface 54 adjacent to, but not in contact with, a surface 56 of cylinder head 17. The length of projection 40 is such that even in case of tolerance extremes surface 54 does not contact surface 56. Projection 40 further comprises a threaded longitudinal passage 50 adapted to receive an externally threaded tubular member, such as sleeve 52. Sleeve 52 has a longitudinal passage 58 adapted to receive a fastener such as bolt 60. It further comprises an engagement portion such as external portion 61 or internal portion 63 as shown in FIG. 4, for manual or tool engagement, and an end surface 53 that is in contact with surface 56 of cylinder head 17. End surface 53 is shown in direct contact with surface 56, however another object such as a washer or a bracket (not shown) can be fitted in between end surface 53 and surface 56. Bolt 60 has a threaded portion 62 that engages with a threaded hole 64 in cylinder block 17 to secure sleeve 52 to cylinder block 16.

Assembly of the bracket mounting arrangement is as follows. Cylinder heads 16 and 17 and cylinder block 15 are pre-assembled as part of engine 14. Mounting bracket 10 is positioned adjacent to cylinder block 15 and cylinder head 17. Surface 43 of projection 42 and surface 44 of block 15 are positioned such that surface 43 and surface 44 make contact and that fastener 46 can be fitted through passage 45 and threaded into hole 48. If preferred an adhesive such as Loctite 243 or a locking washer or similar can be applied, but at his stage fastener 46 will not be given its required torque to ease the alignment of fastener 60 and hole 64 in cylinder head 17. Once fastener 60 and hole 64 are aligned and partially engaged, fastener 46 will be given its substantially correct torque. As with fastener 46, an adhesive such as Loctite 243, or a locking washer or similar can be applied to fastener 60.

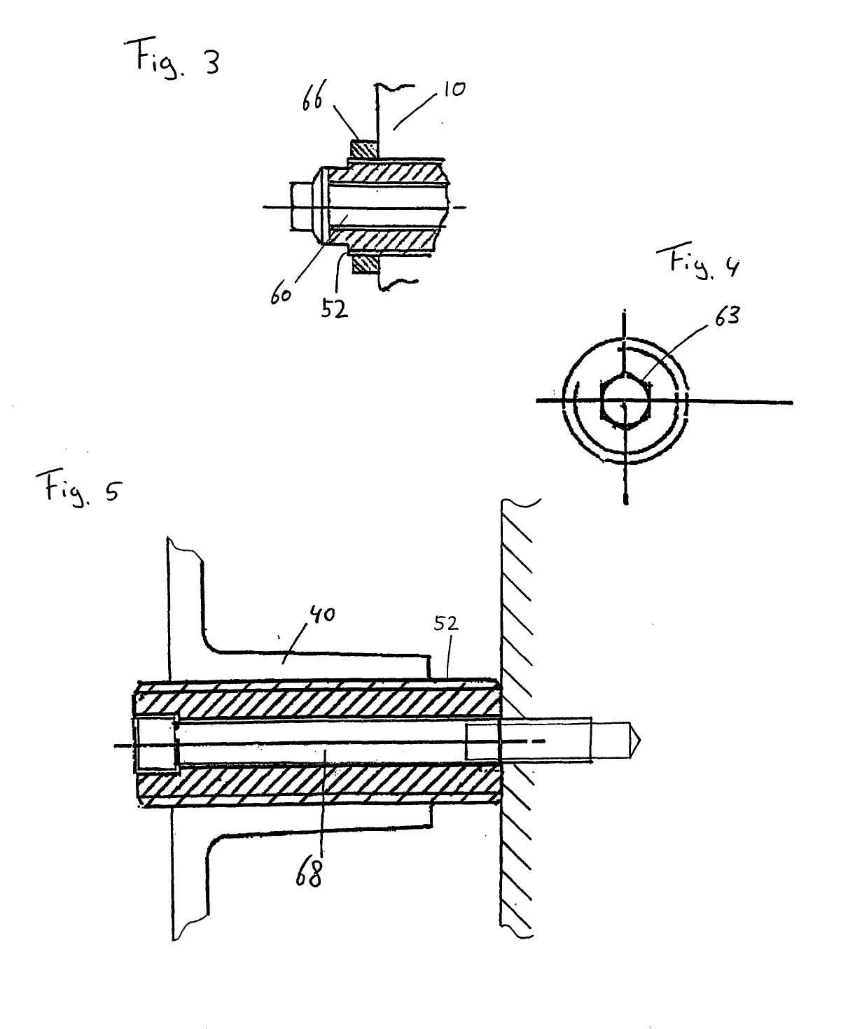

Whilst aligning fastener 60 with hole 64, sleeve 52 is positioned in projection 40 such that end surface 53 and cylinder head surface 56 do not make contact. Before or after fastener 46 has been given its substantially correct torque, sleeve 52 is positioned on an axis 55, axis 55 being transverse, but not necessarily at a right angle, to the direction of the load from the accessories. Sleeve 52 is engaged further at engagement portion 61 to cause a screw like motion through projection 52. The engagement can be manually or by use of a suitable tool such as a spanner. After end surface 53 makes contact with surface 56, a torque is applied to pre-load the connection between projection 40 and sleeve 52 to reduce relative movement of the threaded surfaces of projection 40 and sleeve 52 during operation. If preferred, sleeve 61 can be secured in projection 40 by use of an adhesive such as Loctite 243 or a locknut 66 (FIG. 3) threaded onto the exterior surface of sleeve 52. After the above operation has been completed fastener 60 is tightened to the correct torque and if required fastener 46 can be retightened also.

The accessories to be fitted to the bracket can be fitted before or after the bracket is mounted to the engine.

One variation of the present disclosure replaces a bolt-type fastener such as fastener 46 with a stud and nut arrangement (not shown). For example, a bar (not shown) with at least one threaded portion is engaged in a preferably threaded fashion with hole 48 of cylinder block 15. After mounting bracket 10 has been positioned on the bar, a nut is threaded onto the bar to secure mounting bracket 10.

With reference to FIG. 5., a variation of the present disclosure is substantially similar, but sleeve 52 is countersunk (not shown) and adapted to take a fastener of the socket type such as an Allen screw 68.

In yet another variation of the present disclosure the tubular member is not threadingly, but slidably engaged with projection 40. Once the tubular member is in the desired position, it can be secured to projection 40 by a welding process or an adhesive. For an alternative locking method of the slideable tubular member, the external surface of the tubular member can have partially threaded portions to accommodate locknuts at either end of the tubular member.

Another embodiment of the present disclosure (not shown) is substantially similar, but not all or none of fasteners 46 and 60 extend through projections 40 and 42. In this case projections 40 and 42, and the tubular member previously designated as sleeve 52 do not need to have longitudinal passages. The fasteners previously designated 46 and 60 will then be acting upon other parts of bracket 10. Preferably however, the fasteners still engage the surfaces 43 and 44 near the part of contact between the bracket 10 and the adjustment member 52 and respective surfaces 43 and 44.

### INDUSTRIAL APPLICABILITY

This disclosure provides a solution for mounting components to two or more surface which are not aligned and of which their relative positions are not exactly known due to manufacturing tolerances or otherwise. The bracket arrangement, which is adjustable to overcome manufacturing tolerances found on the surfaces it will be mounted to, can be fitted without introducing unwanted residual stress in the bracket.

During fitment, mounting bracket 10 is disposed adjacent the mounting surfaces, such that fixed projection 42 contacts surface 44. Projection 40 is positioned adjacent end surface 53, but projection 40 and end surface 53 are not in contact. Tubular member 52 is adjusted until surfaces 53 and 56 are in contact and secured in position. After applying the correct torque to prevent thread clatter between projection 40 and member 52, fasteners 46 and 60 are tightened to the required torque.

This disclosed mounting bracket arrangement is particularly useful for mounting external accessories to internal combustion engines, where belt driven accessories have to be lined up with a crankshaft pulley. As this requires all pulleys to be in substantially the same plane, a bracket has to be in place to provide a plurality of fixing points, and to distribute the forces generated by the weight and operation of the accessories over the engine. To distribute the forces over the engine, the bracket is likely to be fitted to multiple mounting points located on both the cylinder block and the cylinder head. The relative positions of the cylinder block and the cylinder head can vary due to manufacturing and assembly tolerances. If a conventional non-adjustable bracket would be used, the bracket is highly likely to suffer from residual stress due the varying positions of the blocks and heads, therefore running the risk of fatigue during operation. The risk is aggravated by the high level of vibration the bracket may be exposed to during engine operation. The vibrations are caused by the engine itself and by the accessories and their subsystems.

Those skilled in the art will recognize that the disclosed mounting bracket arrangement may be used in environments other than mounting accessories to an internal combustion engine

Although the preferred embodiments of this disclosure have been described herein, improvements and modifications may be incorporated without departing from the scope of the following claims.

### LIST OF ELEMENTS

10 Mounting bracket
11 Surface
12 Mounting bracket
14 Internal combustion engine
15 Cylinder block
16 Cylinder head
17 Cylinder head
18 Air-conditioning compressor
19 Air-conditioning compressor
20 Vacuum pump
22 Alternator
24 Steering pump
26 Crankshaft pulley
28 Coolant pump
30 Drive belt
32 Idler pulley
34 Idler pulley
36 Belt tensioner
40 First projection
42 Second projection
43 Surface
44 Surface
45 Longitudinal passage
46 Bolt
47 Threaded portion
48 Threaded hole
50 Longitudinal passage
52 Sleeve
53 End surface
54 Surface
56 Surface
58 Longitudinal passage
60 Bolt
61 External portion
62 Threaded portion
63 Internal portion
64 Threaded hole
66 Locknut
68 Allen screw

1. A mounting bracket arrangement, comprising:
a first surface lying substantially in a first plane;
a second surface lying substantially in a second plane;
a mounting bracket having a portion contacting said first surface, said bracket having a passage extending therethrough adjacent said second surface; and
an adjustment member positioned in said passage and having an end surface contacting said second surface, said adjustment member being adjustable along an axis and said bracket being adapted to support a load transverse to the axis.

2. A mounting bracket arrangement according to claim 1, wherein said adjustment member is threadedly engaged in said passage.

3. A mounting bracket arrangement according to claim 2, wherein the adjustment member is secured in said passage by an adhesive.

4. A mounting bracket arrangement according to claim 1, wherein the adjustment member is secured in said passage by a locknut.

5. A mounting bracket arrangement according to claim 2, wherein the adjustment member is secured in said passage by a locknut.

6. A mounting bracket arrangement according to claim 1, wherein at least one removable fastener secures at least one of said bracket and said adjustment member to at least one of said surfaces.

7. A mounting bracket arrangement according to claim 2, wherein at least one removable fastener secures at least one of said bracket and said adjustment member to at least one of said surfaces.

8. A mounting bracket arrangement according to claim 6, wherein the adjustment member has a longitudinal passage and said fastener extends through said passage.

9. A mounting bracket arrangement according to claim 7, wherein the adjustment member has a longitudinal passage and said fastener extends through said passage.

10. A mounting bracket arrangement according to claim 6, wherein said portion of the mounting bracket that contacts said first surface has a passage and said fastener extends through said passage.

11. A mounting bracket arrangement according to claim 7, wherein said portion of the mounting bracket that contacts said first surface has a passage and said fastener extends through said passage.

12. A mounting bracket arrangement according to claim 1, wherein the adjustment member has a portion adapted for manual or tool engagement.

13. A method for mounting an article to a first surface lying substantially in a first plane and a second surface lying substantially in a second plane, comprising:
a) positioning a mounting bracket adjacent said first and second surfaces;
b) causing a portion of said mounting bracket to contact said first surface;
c) engaging an adjustment member in a passage extending through the bracket adjacent to the second surface;
d) adjusting the position of said adjustment member along an axis until an end surface of said adjustment member contacts said second surface; and
e) mounting an article to the bracket such that said bracket supports a load from the article transverse to said axis.

14. A method according to claim 13, wherein said adjustment member is threadedly engaged in said passage.

15. A method according to claim 13, wherein the adjustment member is secured in said passage by an adhesive.

16. A method according to claim 13, wherein the adjustment member is secured in said passage by a locknut.

17. A method according to claim 13, wherein at least one removable fastener secures at least one of said bracket and said adjustment member to at least one of said surfaces.

18. A method according to claim 17, wherein the adjustment member has a longitudinal passage and said fastener extends through said passage.

19. A method according to claim 17, wherein said portion of the mounting bracket that contacts said first surface has a passage and said fastener extends through said passage.

20. An internal combustion engine, comprising;
a cylinder head;
a cylinder block;
a mounting bracket arrangement according to claim 1, fixed in relation to the cylinder head and the cylinder block; and
at least one article mounted to the bracket of the arrangement.
